(19) United States
(12) Patent Application Publication
(10) Pub. No.: US 2022/0258073 A1
(43) Pub. Date: Aug. 18, 2022

(54) DEVICE FOR DEGASSING A LIQUID FLOWING IN A LIQUID LINE

(71) Applicant: NORMA Germany GmbH, Maintal (DE)

(72) Inventors: Daniel Kintea, Maintal (DE); Gerrit Von Breitenbach, Maintal (DE); Jean-Luc Kirmann, Maintal (DE); Dennis Unger, Maintal (DE)

(21) Appl. No.: 17/609,900

(22) PCT Filed: Apr. 22, 2020
(86) PCT No.: PCT/EP2020/061182

§ 371 Date: Nov. 9, 2021

(30) Foreign Application Priority Data
May 9, 2019 (DE) 10 2019 112 196.5

(51) Int. Cl. B01D 19/00

(52) U.S. Cl. CPC B01D 19/0042; B01D 19/0063; B01D 19/0031; B01D 19/0073

(57) ABSTRACT

A device for degassing a liquid flowing in a liquid line is provided. The device has an inlet opening, an outlet opening, and a capillary element having an inner wall surface. The capillary element extends between the inlet opening and the outlet opening. The inlet opening is connected in a fluid-communicating manner to the outlet opening and is connected in a fluid-communicating manner to the liquid line. The inner wall surface has a material that is liquid-repellent for a liquid flowing in the liquid line. A device is thus provided for degassing a liquid flowing in a liquid line that reduces the time needed for degassing.

### INTRODUCTION

The disclosure relates to a device for degassing a liquid flowing in a liquid line.

In cooling systems or temperature management systems, in particular of electric vehicles, liquids are used to redistribute thermal energy. Here, the liquids are carried in liquid lines. To increase the efficiency of thermal energy transfer, it is necessary in this case to remove from the liquid lines gases which are located in the liquid lines or penetrate into the liquid lines because of leaks. The liquid lines are therefore regularly degassed.

For this purpose, there is a known practice of providing valves on the liquid lines, with which a user can release the gas from the liquid line by opening the valve. In this case, the user opens the valve until the gas has flowed out and liquid emerges from the valve. This process is repeated by the user at regular intervals in order to regularly remove gases which have penetrated into the liquid line from the system. However, this is a time-consuming and thus cost-intensive process.

### SUMMARY

It can therefore be considered to be an object of an embodiment of the disclosure to provide a device for degassing a liquid flowing in a liquid line that reduces the time required for degassing.

In an embodiment, a device for degassing a liquid flowing in a liquid line is provided, wherein the device has an inlet opening, an outlet opening and a capillary element having an inner wall surface, wherein the capillary element extends between the inlet opening and the outlet opening and connects the inlet opening in a fluid-communicating manner to the outlet opening, wherein the inlet opening is connected in a fluid-communicating manner to the liquid line, wherein, according to an embodiment, it is envisaged that the inner wall surface comprises a material that is liquid-repellent for a liquid flowing in the liquid line.

An embodiment provides automatic degassing for liquid lines, wherein the liquid remains inside the liquid line because of the liquid-repellent inner wall surface of the capillary element and only gases which are present in the liquid can escape from the liquid line through the capillary element. In this case, the inner wall surface of the capillary element is the boundary for a flow channel through the capillary element. Here, the inner wall surface is in direct contact with the fluid arranged in the flow channel. In this context, the material is selected in such a way that the material repels a liquid which flows through the liquid line. This means that wetting of the material by the liquid is more difficult than wetting of a material which is not liquid-repellent. Furthermore, an angle between the liquid surface at the inner wall surface in the capillary element and the inner wall surface covered by the liquid is greater than 90°. This causes an increase in the pressure of the liquid in the capillary compared to an undisturbed liquid. This drives the liquid out of the capillary element in the direction of the inlet opening until there is an equilibrium between the static pressure of the liquid and the pressure brought about by the surface tension. Since the material does not influence gases in this way, gases require only a low pressure in order to flow through the capillary element. The capillary element thus provides a capillary which prevents the liquid arranged in the liquid line from being transported through the capillary because of the liquid-repellent material of the inner wall surface and only allows gases to pass from the inlet opening to the outlet opening. In this case, the outlet opening is connected in a fluid-communicating manner to an environment of the liquid line, wherein the gases escape into the environment through the outlet opening. In this way, continuous automatic degassing of the liquid line is carried out, thereby reducing the expenditure of time for a user.

The material can be hydrophobic when a polar liquid flows in the liquid line and/or lipophobic when a nonpolar liquid flows in the liquid line.

A polar liquid can be water, for example, and therefore a hydrophobic material is selected for the inner wall surface of the capillary element when water is passed through the liquid line. Thus, the water cannot wet the inner wall surface of the capillary element and is kept away from the capillary element if the water pressure is not sufficient to overcome the pressure difference which is generated at the inner wall surface. A nonpolar liquid can be an oil, for example. In this case, oil would be passed through the liquid line. A lipophobic material would therefore have to be selected as the material for the inner wall surface. In this case, the material may also be amphiphobic, i.e. both hydrophobic and lipophobic. In this case, the material repels both polar and nonpolar liquids.

The capillary element can have a breakthrough pressure for the liquid flowing in the liquid line which is greater than a maximum pressure of the liquid in the liquid line, wherein, when the breakthrough pressure is exceeded, the liquid flows from the inlet opening to the outlet opening through the capillary element.

The material which is arranged on the inner wall surface can in this case be selected so that such a high pressure is generated at the surface of the liquid in the capillary element that a maximum pressure of the liquid which can arise in the liquid line is not sufficient to build up a counterpressure which allows the liquid to pass through the capillary element. Thus, the liquid can at no time flow through the capillary element from the inlet opening to the outlet opening. The capillary element is thus sealed with respect to the liquid flowing in the liquid line.

The capillary element can furthermore be widened at the inlet opening.

The widening of the capillary element at the inlet opening has the effect that, on the one hand, the liquid can penetrate further into the capillary element since a lower pressure is generated at the widening by the surface of the liquid in the capillary element, but, on the other hand, gases which flow past the inlet opening in the form of gas bubbles are more likely to pass through the inlet opening into the capillary element. This improves the effectiveness of the degassing process with the device.

Furthermore, the device can have a multiplicity of capillary elements.

By providing a multiplicity of capillary elements, the effective surface area with which the degassing can be carried out is increased. A larger quantity of gas can thus be removed from the liquid at the same time.

According to one example, the device can comprise a multiplicity of wire elements which are arranged parallel to one another and extend between the inlet opening and the outlet opening, wherein the multiplicity of capillary elements is arranged between the wire elements and the wire elements comprise the material at least at an outer surface.

The multiplicity of wire elements which are arranged parallel to one another have interspaces which form the capillary elements. In this case, the wire elements comprise the liquid-repellent material on their outer surface or consist entirely of the liquid-repellent material. This provides a multiplicity of capillary elements between the inlet opening and the outlet opening in a simple manner.

In this case, the multiplicity of wire elements can be frayed at the inlet opening.

By fraying the wire elements at the inlet opening, the capillary elements are widened at the inlet opening. The penetration of gases into the capillary elements, which can be present in the liquid as gas bubbles, is thus facilitated.

In another example, the device can have a porous object which extends between the inlet opening and the outlet opening, wherein the multiplicity of capillary elements is arranged in the porous object. In this case, the capillary elements are formed by the pores of the porous object. The porous object can be a sintered component, a mesh or a membrane made of a hydrophobic and/or lipophobic material, for example polytetrafluoroethylene.

Providing a sintered component, a mesh or a membrane made of the liquid-repellent material requires little effort in order to provide capillary elements. The sintered component, the mesh or the polytetrafluoroethylene membrane is positioned between the inlet opening and the outlet opening in order to install the capillary elements.

Furthermore, the device can have a protection element, which is arranged over the outlet opening.

By means of the protection element, contamination of the capillary elements at the outlet opening can be reduced. In this case, the protection element does not close the outlet opening in a gastight manner, but is designed to be gas-permeable.

The device can furthermore have a valve, which closes the outlet opening in a first functional position and opens the outlet opening in a second functional position.

The outlet opening is closed in a gastight manner by means of the valve. The valve is opened to transport the gas of the liquid line when gas has collected at the outlet opening. This further improves the protection of the capillary elements against dirt at the outlet opening. Furthermore, it enables vacuum tests of the liquid line, in which the liquid line is examined for leaks. In this case, when a vacuum is applied, the valve is closed, with the result that no air can flow from the outlet opening into the liquid line through the capillary element and the inlet opening.

In this context, the valve can be a check valve which changes to the second functional position when a pressure difference at the valve is greater than a predefined threshold value.

Here, the valve is designed in such a way that it opens the outlet opening only at a gas pressure which is predetermined by the predefined threshold value, thus enabling the gas to flow out.

Furthermore, a liquid line is provided, wherein the liquid line comprises a curved piece having an outer radius and a device in accordance with the preceding description, wherein the inlet opening is connected to the curved piece at the outer radius.

Advantages and effects as well as further developments of the liquid line can be derived from the advantages and effects as well as further developments of the above-described device. In this regard, attention is therefore drawn to the preceding description.

By means of the curved piece, the liquid flowing through the liquid line is guided around a curve. In this case, the inlet opening of the device is arranged on an outer radius of the curved piece. Gas bubbles in the liquid are forced to the outer radius of the curved piece by inertia as they flow through the curved piece. At this point, they can flow through the inlet opening into the capillary elements. This facilitates the degassing of the liquid.

The liquid line can have a line end piece, wherein the line end piece is connected to the curved piece.

The liquid line with the device can thus be connected in a simple manner to a further liquid line in order to provide degassing of an entire liquid line system. Furthermore, it is possible here for the liquid line to have a quick-action connector, by means of which the line end piece can be connected to a further line end piece of the further liquid line.

### BRIEF DESCRIPTION OF THE FIGURES

Further features, details and advantages of the disclosure can be derived from the wording of the claims and from the following description of exemplary embodiments with reference to the drawings. In the drawings:

FIGS. 1a, b show a schematic illustration of a liquid line in several exemplary embodiments with a device for degassing a liquid flowing in a liquid line;

FIGS. 2a, b show a schematic illustration of a capillary element with a hydrophilic and hydrophobic inner wall surface;

FIGS. 3a-d show a schematic illustration of various exemplary embodiments for providing capillary elements; and

FIGS. 4a, b show a schematic illustration of systems that have the device.

### DETAILED DESCRIPTION

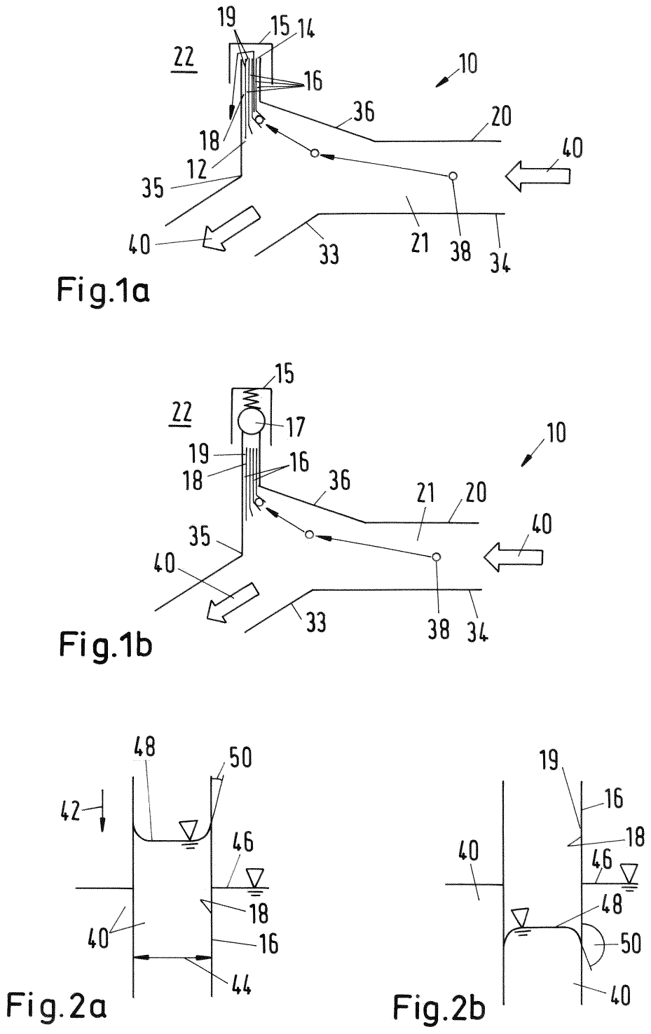

FIG. 1a illustrates a device 10, which is connected to a liquid line 20.

Here, the device 10 comprises an inlet opening 12, an outlet opening 14 and a capillary element 16. In this case, the device 10 has a multiplicity of capillary elements 16. The inlet opening 12 is connected in a fluid-communicating manner to a flow channel 21 of the liquid line 20. Furthermore, the capillary element 16 connects the outlet opening 14 to the inlet opening 12 in a fluid-communicating manner. The outlet opening 14 is connected to the environment 22 of the liquid line 20 in a fluid-communicating manner.

Hence, the flow channel 21 is connected to the environment 22 in a fluid-communicating manner via the device 10.

The capillary element 16 has an inner wall surface 18, which delimits a flow channel of the capillary element 16. Arranged on the inner wall surface 18 is a material 19 which is liquid-repellent with respect to the liquid 40 which flows through the liquid line 20. In this case, the material 19 is hydrophobic when the liquid 40 is polar. When the liquid 40 is nonpolar, the material 19 is lipophobic.

Furthermore, the capillary element 16 is widened at the inlet opening 12. That is to say that the capillary element 16 tapers from the inlet opening 12 to the outlet opening 14.

In this case, the device 10 is arranged on an outer radius 35 of a curved piece 33 of the liquid line 20. The flow of the liquid 40 is indicated by the arrows. A gas bubble 38 which is present in the liquid 40 is conveyed in the direction of the outer radius 35 by the inertia at the curved piece 33. At this point, the gas bubble 38 flows through the inlet opening 12 and is received by the widened end of the capillary element 16. In the process, the gas bubble 38 penetrates into the capillary element 16 and flows through the capillary element 16 to the outlet opening 14 and from there into the environment 22. In order to facilitate the trapping of the gas bubbles 38 at the inlet opening 12, the liquid line 20 has a funnel element 36 in front of the curved piece 33 which promotes a flow of the gas bubbles 38 in the direction of the outer radius 35.

The curved piece 33 can be arranged on a line end piece 34, wherein the line end piece 34 can have a quick-action connector.

A protection element 15, which surrounds the outlet opening 14, is arranged over the outlet opening 14. The protection element 15 keeps dirt particles away from the outlet opening 14 in order to counteract clogging of the capillary element 16. At the same time, the protection element 15 does not cover the outlet opening 14 in a gastight manner. In this case, the protection element 15 can be designed as a cap.

FIG. 1b likewise shows a device 10, which is connected to a liquid line 20. In this context, attention is drawn to the preceding description, with the same reference signs designating the same elements.

Instead of a simple protection element 15 in the form of a cap, the device 10 in this example comprises a valve 17, which is designed as a check valve. Here, the check valve closes the outlet opening 14 in a first functional position. In a second functional position, it opens the outlet opening 14. In this case, the first functional position is the standard position of the check valve, wherein a spring of the check valve presses a closure element of the check valve onto the outlet opening 14. In the first functional position, the valve 17 closes the outlet opening 14 in a gastight manner.

The check valve changes from the first functional position into the second functional position when a gas pressure at the outlet opening 14 is greater than the pressure of the environment 22 in combination with the pressure which is exerted by the spring of the check valve. By means of the pressure of the spring, it is possible to provide a predefined threshold value for the breakthrough pressure.

Thus, the check valve opens when a gas pressure that exceeds the predefined threshold value has formed at the outlet opening 14.

The effect of the material 19 is explained below by means of FIGS. 2a and 2b.

For this purpose, FIG. 2a shows a capillary element 16 which is immersed vertically in a liquid 40. Here, the arrow 42 indicates the direction of gravity. In this case, the capillary element 16 has a flow channel with a radius 44. The flow channel is delimited by the inner wall surface 18 of the capillary element 16. The capillary element 16 shown in FIG. 2a is not designed according to this embodiment but comprises a material which is not liquid-repellent on the inner wall surface. In the case where the liquid 40 is polar, e.g. water, the material according to FIG. 2a is hydrophilic. In the case where the liquid 40 is nonpolar, for example oil, the material in the example according to FIG. 2a is lipophilic. In this case, the material can likewise be amphiphilic.

Here, an angle 50 between the liquid surface 48 and the inner wall surface 18 which is covered by the liquid 40 is less than 90°. In FIG. 2a, the angle 50 is illustrated as the opposite angle of the same size.

The resulting downward surface curvature of the liquid 40 causes a pressure reduction which makes the liquid 40 in the capillary element 16 rise upward counter to gravity until the hydrostatic pressure of the liquid 40, which drops as a result of the rising of the liquid, compensates for this pressure loss. Here, a liquid level 46 indicates the height of an undisturbed liquid 40.

FIG. 2b shows a capillary element 16 designed according to an embodiment. The capillary element 16 is likewise immersed vertically in a liquid 40. Here, too, the liquid level 46 indicates the liquid level of an undisturbed liquid. In contrast to the inner wall surface 18 according to FIG. 2a, the inner wall surface 18 in FIG. 2b has the liquid-repellent material 19. Between the liquid surface 48 in the capillary element 16 and the inner wall surface 18 which is covered by the liquid 40, an angle 50 is formed which is greater than 90°. In FIG. 2a, too, the illustrated angle 50 is the opposite angle of the same size.

By virtue of the angle 50, the surface of the liquid 40 is curved upward. This causes a pressure increase to be produced at the surface of the liquid 40, which pressure increase presses the liquid 40 downward in the capillary element 16 until the hydrostatic pressure of the liquid 40, which increases as the liquid surface drops, compensates for the pressure increase. The liquid surface 48 is therefore arranged below the liquid level 46 of the undisturbed liquid 40. At the same time, the liquid 40 penetrates into the capillary element 16 to only a very small extent.

In order to convey the liquid 40 through the capillary element 16, the liquid 40 must have a higher pressure which counteracts the pressure increase.

In this case, the liquid-repellent material 19 of the device 10 is selected in such a way that a breakthrough pressure of the capillary element 16 for the liquid 40 flowing in the liquid line 20 is greater than a maximum pressure of the liquid 40 which the liquid 40 in the liquid line 20 can assume, even in the case of pressure peaks in the liquid line 20. Here, a liquid 40 which exceeds the breakthrough pressure can flow through the capillary element 16 from the inlet opening 12 to the outlet opening 14.

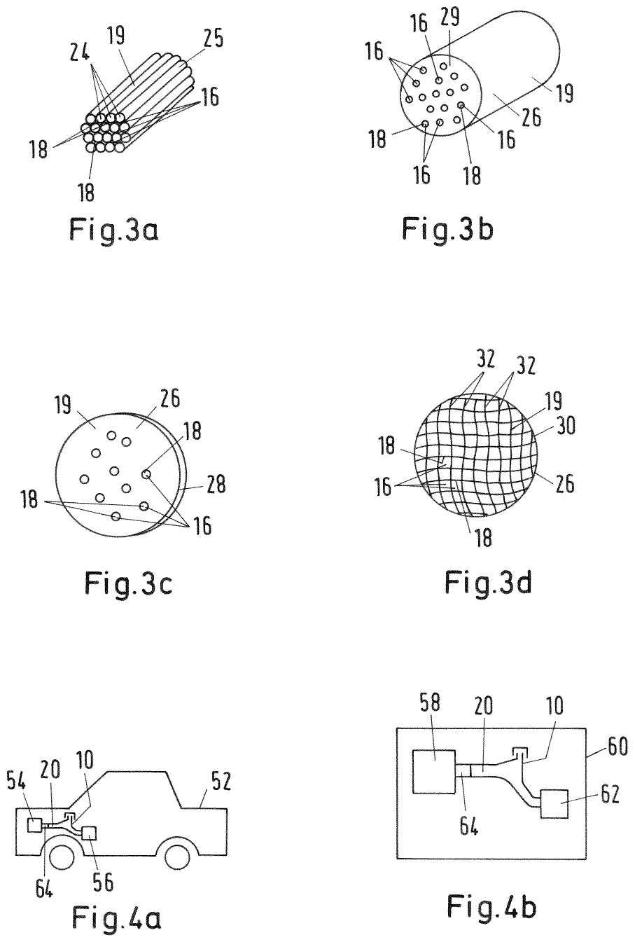

FIGS. 3a to 3d show various exemplary embodiments for providing capillary elements 16.

Here, FIG. 3a shows a bundle of wire elements 24, which are arranged parallel to one another. Arranged between the wire elements 24 is a multiplicity of interspaces, which form a multiplicity of capillary elements 16. In this case, the wire elements 24 are either coated only on their outer surface with the liquid-repellent material 19 or consist entirely of the liquid-repellent material. Thus, the inner surface 18 of the capillary elements 16 has the liquid-repellent material. During the production of the device 10, the bundle of wire elements 24 is arranged between the inlet opening 12 and the outlet opening 14 in order to provide a fluid-communicating connection between the inlet opening 12 and the outlet opening 14 by means of the capillary elements 16.

In the further examples according to FIGS. 3b to 3d, a porous object 26 is provided, wherein the pores of the porous object 26 form the multiplicity of capillary elements 16.

According to FIG. 3b, a sintered component 29 is provided. The sintered component 29 can consist of the liquid-repellent material 19. Alternatively, the sintered component 29 can be subjected to a coating process, which lines the pores with the liquid-repellent material 19.

FIG. 3c shows a porous membrane 28 which is produced from a hydrophobic and/or lipophobic material, for example from polytetrafluoroethylene.

FIG. 3d shows a mesh 30 of wires or threads 32 which have the liquid-repellent material 19 at least on their outer surface. Here, the mesh 30 has pores which are arranged between the wires or threads 32 and in which the capillary elements 16 are arranged.

FIG. 4a shows an electric vehicle 52 with a system 54 for controlling temperatures in components 56 of the electric vehicle 52. Here, the system 54 is connected to the component 56 by means of a liquid line 20. In this context, liquid 40 flows from the system 54 to the component 56. In this case, the liquid line 20 has the device 10 and is connected to the system 54 via a quick-action connector 64. The quick-action connector 64 can be arranged on a line end piece 34 of the liquid line 20. By means of the device 10, the liquid line 20 and the entire system 54 are continuously degassed in an automatic way. A maintenance process for degassing the liquid line 20 is therefore no longer necessary, thus reducing the maintenance costs for the electric vehicle 52.

FIG. 4b shows a cooling water system 60 in which a pump 58 pumps cooling water through a liquid line 20 to a component 62 to be cooled. In this case, the liquid line 20 is connected to the pump 58 via a quick-action connector 64. In addition, the liquid line 20 has the device 10. The cooling water system 60 is therefore automatically degassed, with the result that maintenance of the cooling water system 60 to degas the cooling water system 60 is not required.

The invention is not restricted to one of the above-described embodiments but can be modified in a variety of ways.

All features and advantages arising from the claims, the description and the drawing, including design details, spatial arrangements and method steps, may be essential to the invention, both individually and in the widest possible variety of combinations.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE NUMERALS

10 device
12 inlet opening
14 outlet opening
15 protection element
16 capillary element
17 valve
18 inner surface
19 liquid-repellent material
20 liquid line
21 flow channel
22 environment
24 wire element
26 porous object
28 porous membrane
29 sintered component
30 mesh
32 threads
33 gas bubbles
34 line end piece
35 outer radius
36 funnel element
38 gas bubbles
40 liquid
42 arrow
44 radius
46 liquid level
48 liquid surface
50 angle
52 vehicle
54 system
56 component
58 pump
60 cooling water system
62 component to be cooled
64 quick-action connector

1. A device for degassing a liquid flowing in a liquid line, wherein the device comprises an inlet opening, an outlet opening and a capillary element having an inner wall surface, wherein the capillary element extends between the inlet opening and the outlet opening and connects the inlet opening in a fluid-communicating manner to the outlet opening, wherein the inlet opening is connected in a fluid-communicating manner to the liquid line, wherein the inner wall surface comprises a material that is liquid-repellent for a liquid flowing in the liquid line.

2. The device as claimed in claim 1, wherein the material is hydrophobic when a polar liquid flows in the liquid line and/or is lipophobic when a nonpolar liquid flows in the liquid line.

3. The device as claimed in claim 1, wherein the capillary element has a breakthrough pressure for the liquid flowing in the liquid line which is greater than a maximum pressure of the liquid in the liquid line, wherein, when the breakthrough pressure is exceeded, the liquid flows from the inlet opening to the outlet opening through the capillary element.

4. The device as claimed in claim 1, wherein the capillary element is widened at the inlet opening.

5. The device as claimed in claim 1, wherein the device has a multiplicity of capillary elements.

6. The device as claimed in claim 5, wherein the device comprises a multiplicity of wire elements which extend between the inlet opening and the outlet opening, wherein the multiplicity of capillary elements is arranged between the multiplicity of wire elements and the multiplicity of wire elements comprise the material at least at an outer surface.

7. The device as claimed in claim 5, wherein the multiplicity of wire elements arranged parallel to one another is frayed at the inlet opening.

8. The device as claimed in claim 1, wherein the device has a porous object which extends between the inlet opening and the outlet opening, wherein a multiplicity of capillary elements is arranged in the porous object.

9. The device as claimed in claim 8, wherein the porous object is a sintered component, a mesh or a membrane made of a hydrophobic and/or lipophobic material.

10. The device as claimed in claim 1, wherein the device has a protection element which is arranged over the outlet opening.

11. The device as claimed in claim 1, wherein the device has a valve which closes the outlet opening in a first functional position and opens the outlet opening in a second functional position.

12. The device as claimed in claim 11, wherein the valve is a check valve which changes to the second functional position when a pressure difference at the valve is greater than a predefined threshold value.

13. A liquid line comprising a curved piece having an outer radius and a device as claimed in claim 1, wherein the inlet opening is connected to the curved piece at the outer radius.

14. The liquid line as claimed in claim 13, wherein the liquid line has a line end piece, wherein the line end piece is connected to the curved piece.
